(19) United States
(12) Patent Application Publication
(10) Pub. No.: US 2026/0056709 A1
(43) Pub. Date: Feb. 26, 2026

(54) ATTENTION SCORING DEVICE AND OPERATION METHOD THEREOF

(71) Applicant: NEUCHIPS CORPORATION, Hsinchu City (TW)

(72) Inventors: Shen-Jui Huang, Hsinchu County (TW); Wen-Pin Wang, Hsinchu City (TW)

(73) Assignee: NEUCHIPS CORPORATION, Hsinchu City (TW)

(21) Appl. No.: 18/890,791

(22) Filed: Sep. 20, 2024

(30) Foreign Application Priority Data
Aug. 20, 2024 (TW) 113131260

(51) Int. Cl. G06F 7/50

(52) U.S. Cl. CPC G06F 7/50

(57) ABSTRACT

An attention scoring device and an operating method of the attention scoring device are provided. The attention scoring device includes a pre-processing circuit, a post-processing circuit, a summing circuit, and an arithmetic circuit. The pre-processing circuit performs attention scoring pre-processing by using an input vector to generate an exponential function value and a value vector. The post-processing circuit performs attention scoring post-processing by using the exponential function value and the value vector to generate a linear combination vector. The summing circuit performs summation processing by using the exponential function value to generate a combined value. The arithmetic circuit performs arithmetic processing by using the linear combination vector and the combined value to generate an attention scoring vector corresponding to the input vector.

### CROSS-REFERENCE TO RELATED APPLICATION

This application claims the priority benefit of Taiwan patent application serial no. 113131260, filed on Aug. 20, 2024. The entirety of the above-mentioned patent application is hereby incorporated by reference herein and made a part of this specification.

### BACKGROUND

### Technical Field

The disclosure relates to an artificial intelligence (AI) device; more particularly, the disclosure relates to to an attention scoring device and an operating method thereof.

### Description of Related Art

The calculation of the attention scoring function is a core operation in a self-attention transformer model. The attention scoring computation involves numerous inner products, such as the inner product between a query vector and a key vector, a normalized function (e.g., the Softmax function), and other related computations to generate/output multiple result vectors, known as attention scoring vectors. The normalized function computation involves extensive operations, including finding maximum values, performing subtraction calculations, performing exponential function calculations, performing total value calculations, and performing division computations. The division computation is to divide each exponential function value by the total sum of all exponential function values. As the sequence length increases, the computational load of the division computation escalates significantly.

In general-purpose central processing units (CPUs) or graphics processing units (GPUs), the normalized function calculation is particularly time-consuming. In multi-head self-attention (MSA) applications, compared to single head self-attention applications, the computational load associated with various normalized function computations increases significantly. In other words, the overall execution of the attention scoring function demands substantial time and energy. How to efficiently execute the calculation of the attention scoring function is thus a critical challenge in the field of AI technology.

### SUMMARY

The disclosure provides an attention scoring device and an operating method thereof to efficiently execute the calculation of the attention scoring function.

In an embodiment of the disclosure, an attention scoring device includes a pre-processing circuit, a post-processing circuit, a summing circuit, and an arithmetic circuit. The pre-processing circuit performs attention scoring pre-processing by using at least one input vector to generate at least one exponential function value and at least one value vector corresponding to the at least one input vector. The post-processing circuit is coupled to the pre-processing circuit to receive the at least one exponential function value and the at least one value vector. The post-processing circuit performs attention scoring post-processing by using the at least one exponential function value and the at least one value vector to generate a linear combination vector. The summing circuit is coupled to the pre-processing circuit to receive the at least one exponential function value. The summing circuit performs summation processing by using the at least one exponential function value to generate a combined value. The arithmetic circuit is coupled to the post-processing circuit to receive the linear combination vector. The arithmetic circuit is coupled to the summing circuit to receive the combined value. The arithmetic circuit performs arithmetic processing by using the linear combination vector and the combined value to generate an attention scoring vector corresponding to the at least one input vector.

In an embodiment of the disclosure, an operating method of an attention scoring device includes: performing attention scoring pre-processing by using at least one input vector by a pre-processing circuit of the attention scoring device to generate at least one exponential function value and at least one value vector corresponding to the at least one input vector; performing attention scoring post-processing by using the at least one exponential function value and the at least one value vector by a post-processing circuit of the attention scoring device to generate a linear combination vector; performing summation processing by using the at least one exponential function value by a summing circuit of the attention scoring device to generate a combined value; and performing arithmetic processing by using the linear combination vector and the combined value by an arithmetic circuit of the attention scoring device to generate an attention scoring vector corresponding to the at least one input vector.

Based on the above, in one or more embodiments of the disclosure, the summing circuit performs the summation processing by using the exponential function value generated by the attention scoring pre-processing to generate the combined value. Then, the arithmetic circuit performs the arithmetic processing by using the linear combination vector generated by the attention scoring post-processing and the combined value generated by the summing circuit to generate the attention scoring vector. Compared to the conventional normalized function where the division computation is performed on each of numerous exponential function values (namely, the division computation is performed on each exponential function value before the attention scoring post-processing according to the related art), the arithmetic circuit in one or more embodiments of the disclosure performs the arithmetic processing (e.g., a multiplication computation or the division computation) on the linear combination vector after the attention scoring post-processing. Therefore, the attention scoring device in one or more embodiments of the disclosure may eliminate a significant portion of the division computations typically required in the conventional normalized function, thereby enabling efficient execution of the calculation of the attention scoring function.

To make the aforementioned features and advantages of the disclosure more evident and understandable, exemplary embodiments are described below in detail with reference to the accompanying drawings.

### BRIEF DESCRIPTION OF THE DRAWINGS

FIG. 1 is a schematic flowchart illustrating a calculation process of an attention scoring function.

FIG. 2 is a schematic diagram illustrating a circuit block of an attention scoring device according to an embodiment of the disclosure.

FIG. 3 is a schematic flowchart illustrating an operating method of an attention scoring device according to an embodiment of the disclosure.

FIG. 4A and FIG. 4B are schematic diagrams illustrating circuit blocks of a pre-processing circuit, a post-processing circuit, a summing circuit, and an arithmetic circuit according to an embodiment of the disclosure.

FIG. 5 is a schematic diagram illustrating circuit blocks of a summing circuit and an arithmetic circuit according to another embodiment of the disclosure.

### DESCRIPTION OF THE EMBODIMENTS

The terminology “couple (or connect)” used throughout the whole description of the disclosure (including the claims) may refer to any direct or indirect connection means. For instance, if the disclosure describes that a first device is coupled (or connected) to a second device, it should be interpreted that the first device may be directly connected to the second device, or that the first device may be indirectly connected to the second device through other devices or certain connection means. The terminologies such as “first” and “second” mentioned in the description of the disclosure (including the claims) are only used to name different elements or to distinguish different embodiments or scopes and are not intended to limit the upper or lower limit of the number of the elements, nor are they intended to limit the manufacturing order or disposition order of the elements. Moreover, wherever possible, elements/components/steps with the same reference numbers in the drawings and the embodiments denote the same or similar parts. Cross-reference may be made to related descriptions of elements/components/steps with the same reference numbers or the same terminologies in different embodiments.

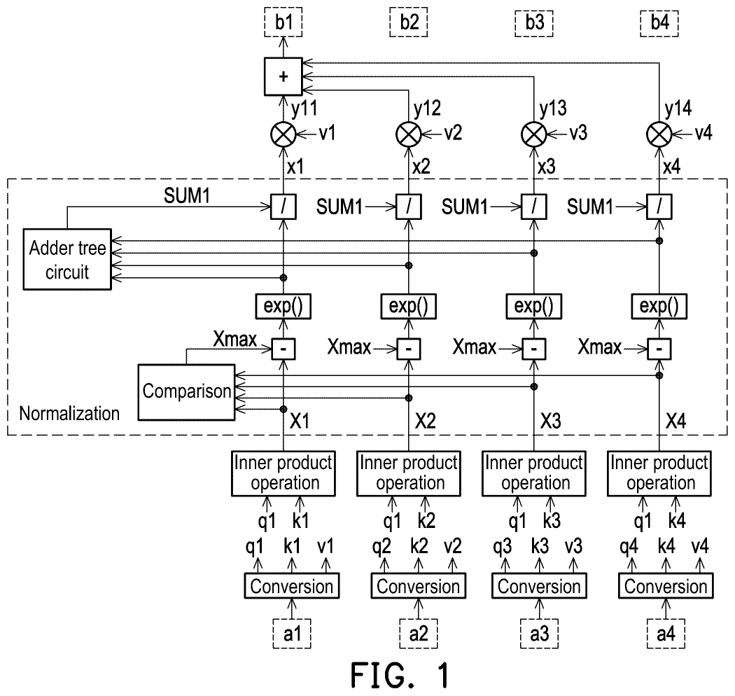

FIG. 1 is a schematic flowchart illustrating a calculation process of an attention scoring function. In the exemplary embodiment shown in FIG. 1, a sequence length is assumed to be 4, meaning there are four input vectors, i.e., input vectors a1, a2, a3, and a4. Generally, the sequence length is greater than 4, e.g., 32, 64, 256, 1024, 2048, 4096, 8192, or even larger. The dimensions of the input vectors a1, a2, a3, and a4 are determined according to the actual design and application requirements. For instance, the dimension of the input vectors may be 10080 or another specified value. As illustrated in FIG. 1, the entire attention scoring computation process may be broadly divided into three stages:
Step 1: The input vectors a1, a2, a3, and a4 are multiplied by a Q matrix, a K matrix, and a V matrix respectively to generate query vectors qi, key vectors ki, and value vectors vi (where i=1 to 4 in the exemplary embodiment shown in FIG. 1). For instance, the input vector a1 multiplied by the Q matrix produces a query vector q1, the input vector a1 multiplied by the K matrix produces a key vector k1, and the input vector al multiplied by the V matrix produces a value vector v1. Similarly, the input vector a2 is converted to a query vector q2, a key vector k2, and a value vector v2; the input vector a3 is converted to a query vector q3, a key vector k3, and a value vector v3; the input vector a4 is converted to a query vector q4, a key vector k4, and a value vector v4.
Step 2: The query vector qi performs an inner product operation with each key vector kj (where j=1 to 4 in the exemplary embodiment shown in FIG. 1). The exemplary embodiment shown in FIG. 1 demonstrates the attention mechanism initiated by the query vector q1. In this scenario, the query vector q1 respectively performs the inner product operations with the key vector k1, the key vector k2, the key vector k3, and the key vector k4 to generate inner product values X1, X2, X3, and X4.
Step 3: The inner product values are processed through a normalized function, such as the Softmax function. Output values xi of the normalized function (where i=1 to 4 in the exemplary embodiment shown in FIG. 1) may represent probability distribution values obtained by applying the exponential function to each inner product value.
Step 4: The output values xi of the normalized function are multiplied by value vectors vi, and then all products yi are linearly combined to generate an output vector bi (the attention scoring vector). For instance, in the operation scenario shown in FIG. 1, where the attention is initiated by the query vector q1, the output values x1, x2, x3, and x4 of the normalized function are multiplied by the value vectors v1, v2, v3, and v4 respectively to generate product vectors y11, y12, y13, and y14. These product vectors y11, y12, y13, and y14 are then linearly combined to generate the output vector b1.

The Q matrix is the query matrix, the K matrix is the key matrix, and the V matrix is the value matrix. The calculation of the other output vectors b2, b3, and b4 follows a similar process to that described for the output vector b1 and may be derived from the relevant description. For instance, if the attention is initiated by the vector q2, then in step 2. the vector q2 performs the inner product operations with the vector k1, the vector k2, the vector k3, and the vector k4 respectively, and then in step 3, these four inner product values undergo the normalized function (e.g., the Softmax function) computation. In step 4, these four output values of the normalized function are multiplied by the vectors v1, v2, v3, and v4 respectively to generate products, and then these four products are linearly combined to generate the output vector b2. Therefore, in the case of the attention initiated by the vector q2. the attention scoring function generates the output vector b2.

The following equation 1 is the Softmax function. The data source for the Softmax function is the inner product values Xi. In the operation scenario shown in FIG. 1, the inner product values are X1, X2, X3, and X4. The first step of the Softmax function involves comparing all inner product values Xi to identify a maximum inner product value Xmax among the inner product values. Once the maximum value is determined, the Softmax function proceeds with a subtraction operation (i.e., “−” shown in FIG. 1) and an exponential operation (i.e., “exp( )” shown in FIG. 1) to calculate exp(Xi−Xmax). In the operation scenario shown in FIG. 1, the Softmax function generates exponential calculation results exp(X1−Xmax), exp (X2−Xmax), exp(X3−Xmax), and exp(X4−Xmax).). An adder tree shown in FIG. 1 sums all exponential calculation results exp(Xi−Xmax) to obtain the denominator in Equation 1, referred to as the Total Value SUMI shown in FIG. 1. Each exponential calculation result exp(X1−Xmax) is divided by the Total Value SUMI, as indicated by the division operation “/” in FIG. 1. Dividing each exponential calculation result exp(X1−Xmax) by the Total Value SUM1 yields the output value of the normalized function for each node <qi,ki,vi> (i.e., xi=softmax(Xi)).

$$Softmax ( Xi ) = \frac{{e}^{Xi - Xmax}}{{\sum }_{j = 1}^{n} {e}^{Xj - Xmax}} , i = 1 , 2 , … , n \qquad Equation 1$$

As shown in FIG. 1, the entire process of calculating the attention scoring function involves a significant amount of exponential functions (i.e., “exp( )” shown in FIG. 1) and division computations (i.e., “/” shown in FIG. 1). Although FIG. 1 illustrates the single head self-attention as an explanatory example, the same principles apply to MSA. If the number of heads in the MSA is assumed to be h (e.g., h may be 8, 16, 32, or another value), each node <qi,ki,vi> generates h sub-nodes by multiplying with the corresponding matrix. Each sub-node then undergoes the same attention calculation process as illustrated in FIG. 1. Therefore, in MSA applications, the total computation of the attention scoring function scales approximately by a factor of h. For instance, if the sequence length is I and the number of heads in the MSA is h, then in the MSA applications, the number of division computations (i.e., “/” shown in FIG. 1) in the Softmax function is l*h. According to the following embodiments, the number of division computations in the normalized function shown in FIG. 1 may be significantly reduced or eliminated, thereby efficiently executing the calculation of the attention scoring function.

To reduce the computational load of the attention scoring function, the attention scoring function described in FIG. 1 is re-derived as shown in Equation 2. Here, Srcp represents the reciprocal of the Total Value SUM1, which is the reciprocal of the denominator in Equation 1.

$$\begin{matrix}b 1 = exp ( X 1 - Xmax ) * Srcp * v 1 + exp ( X 2 - Xmax ) * Srcp * v 2 + \\ exp ( X 3 - Xmax ) * Srcp * v 3 + exp ( X 4 - Xmax ) * Srcp * v 4 \\ = Srcp * ( exp ( X 1 - Xmax ) * v 1 + exp ( X 2 - Xmax ) * v 2 + \\ exp ( X 3 - Xmax ) * v 3 + exp ( X 4 - Xmax ) * v 4 )\end{matrix} \qquad Equation 2$$

From Equation 2, it can be observed that the common term Srcp may be factored out, thus eliminating the need to multiply each exp(Xi−Xmax) term by Srcp. The original division operation has been converted to a multiplication operation, which is generally less computationally intensive and less time-consuming in computation than the division operation. Using Equation 2, the following calculation process may be implemented:
Step 1: Each exponential calculation result exp(Xi−Xmax) is directly multiplied by the value vector vi to generate a product vector y′i.
Step 2: The product vectors y′i are then linearly combined to generate a linear combination vector r1.
Step 3: The reciprocal Srcp is multiplied by the linear combination vector r1 to generate the output vector b1.

Through the above steps, the original execution method of the normalized function (e.g., the Softmax function) is modified and integrated with the generation of the output vector b1. Although the following embodiments are explained using single head self-attention, the same principles may be extended to the MSA, effectively reducing the overall computational load in the MSA applications.

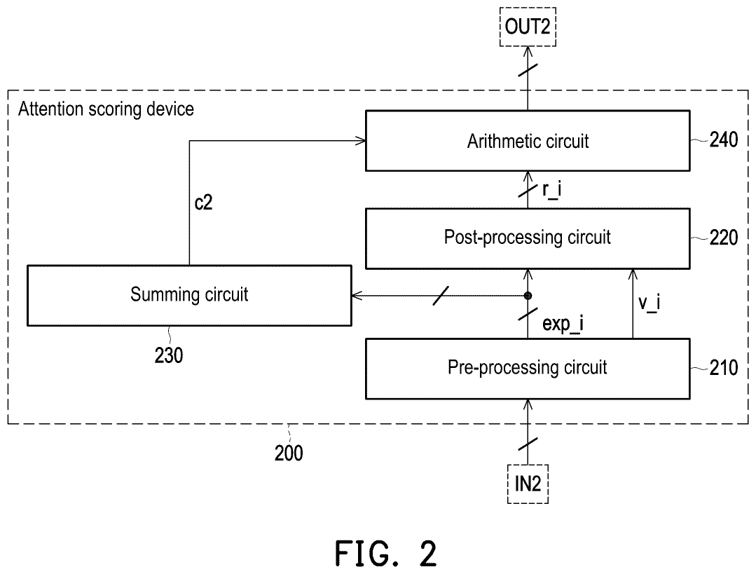

FIG. 2 is a schematic diagram illustrating a circuit block of an attention scoring device according to an embodiment of the disclosure. An attention scoring device 200 shown in FIG. 2 includes a pre-processing circuit 210, a post-processing circuit 220, a summing circuit 230, and an arithmetic circuit 240. The pre-processing circuit receives at least one input vector IN2. The quantity of the at least one input vector IN2 is associated with the sequence length. The post-processing circuit 220 and the summing circuit 230 are coupled to the pre-processing circuit 210 to receive at least one exponential function value exp_i. The quantity of the exponential function value exp_i is associated with the quantity of the at least one input vector IN2. The post-processing circuit 220 further receives at least one value vector v_i from the pre-processing circuit 210. The quantity of the value vector v_i is associated with the quantity of the at least one input vector IN2. The arithmetic circuit 240 is coupled to the post-processing circuit 220 to receive at least one linear combination vector r_i. The arithmetic circuit 240 is coupled to the summing circuit 230 to receive a combined value c2.

According to different designs, in some embodiments, the pre-processing circuit 210. the post-processing circuit 220, the summing circuit 230, and/or the arithmetic circuit 240 may be implemented in form of hardware circuits. In some other embodiments, the pre-processing circuit 210, the post-processing circuit 220, the summing circuit 230, and/or the arithmetic circuit 240 may be implemented in form of a combination of hardware, firmware, and software (i.e., programs).

In terms of the hardware form, the pre-processing circuit 210, the post-processing circuit 220, the summing circuit 230, and/or the arithmetic circuit 240 may be implemented as logic circuits on an integrated circuit. For instance, the related functions of the pre-processing circuit 210, the post-processing circuit 220, the summing circuit 230, and/or the arithmetic circuit 240 may be implemented in one or more hardware controllers, microcontrollers, hardware processors, microprocessors, application-specific integrated circuits (ASIC), digital signal processors (DSP), field programmable gate arrays (FPGA), central processing units (CPU), and/or various logic blocks, modules, and circuits in other processing units. The related functions of the pre-processing circuit 210, the post-processing circuit 220, the summing circuit 230, and/or the arithmetic circuit 240 may be implemented as hardware circuits, such as various logic blocks, modules, and circuits in integrated circuits, by using hardware description languages (e.g., Verilog HDL or VHDL) or other suitable programming languages.

In terms of software and/or firmware form, the related functions of the pre-processing circuit 210, the post-processing circuit 220, the summing circuit 230, and/or the arithmetic circuit 240 may be implemented as programming codes. For instance, the pre-processing circuit 210, the post-processing circuit 220, the summing circuit 230, and/or the arithmetic circuit 240 may be implemented by using general programming languages (for instance, C, C++, or assembly language) or other suitable programming languages. The programming codes may be recorded/stored in a “non-transitory machine-readable storage medium.” In some embodiments, the non-transitory machine-readable storage medium may include, for instance, a semiconductor memory and/or a storage device. Electronic devices (e.g., computers, CPUs, hardware controllers, microcontrollers, hardware processors, or microprocessors) may read and execute the programming codes from the non-transitory machine-readable storage medium, thereby implementing the related functions of the pre-processing circuit 210, the post-processing circuit 220, the summing circuit 230, and/or the arithmetic circuit 240.

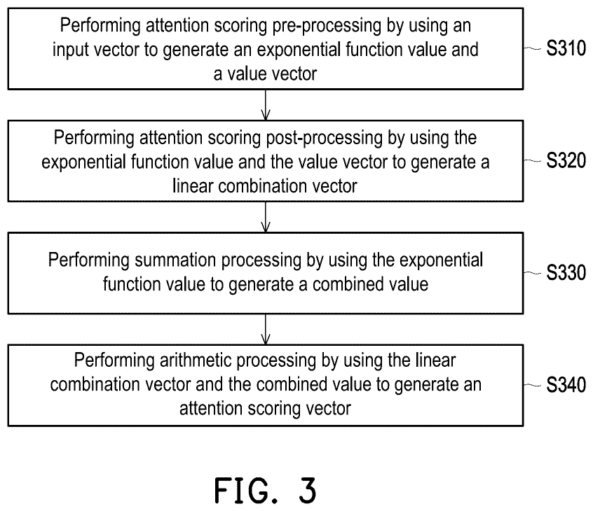

FIG. 3 is a schematic flowchart illustrating an operating method of an attention scoring device according to an embodiment of the disclosure. With reference to FIG. 2 and FIG. 3, in step S310, the pre-processing circuit 210 performs attention scoring pre-processing by using at least one input vector IN2 to generate an exponential function value exp_i and a value vector v_i corresponding to the at least one input vector IN2. For instance, the attention scoring pre-processing includes the following but should not be limited thereto: the pre-processing circuit 210 converts each input vector IN2 into a query vector, a key vector, and a value vector; the pre-processing circuit 210 performs an inner product computation by applying the query vector and the key vector to generate at least one inner product; the pre-processing circuit 210 compares the at least one inner product to find a maximum inner product; the pre-processing circuit 210 performs a subtraction computation by using the at least one inner product and the maximum inner product to generate at least one difference; and pre-processing circuit 210 performs an exponential function computation by using the at least one difference to generate the exponential function value exp_i.

In the description above, the operation of converting the at least one input vector IN2 into the query vector, the key vector, and the value vector includes the following: the pre-processing circuit 210 multiplies the at least one input vector IN2 by different trained weights to generate the query vector, the key vector, and the value vector corresponding to the at least one input vector IN2. For instance, the Q matrix, the K matrix, and the V matrix (trained weights) are multiplied by a certain vector in the at least one input vector IN2 (for instance, the input vector a1) to generate the query vector q1. the key vector k1, and the value vector v1 corresponding to the input vector a1.

With reference to FIG. 2 and FIG. 3. in step S320, the post-processing circuit 220 performs attention scoring post-processing by using the exponential function value exp_i and the value vector v_i to generate a linear combination vector r_i. For instance, the attention scoring post-processing includes but is not limited to the following: the post-processing circuit 220 performs a multiplication computation by using the exponential function value exp_i and the value vector v_i to generate at least one product vector y′i; the post-processing circuit 220 performs a linear combination computation by using the at least one product vector y′i to generate the linear combination vector r_i. Based on practical design and application requirements, in some embodiments, the linear combination computation includes: the post-processing circuit 220 performs an addition computation by using the at least one product vector y′i to generate the linear combination vector r_i.

With reference to FIG. 2 and FIG. 3, in step S330, the summing circuit 230 performs summation processing by using the exponential function value exp_i to generate a combined value c2. In step S340, the arithmetic circuit 240 performs arithmetic processing by using the linear combination vector r_i and the combined value c2 to generate an attention scoring vector OUT2 corresponding to the at least one input vector IN2. For instance, in some embodiments. the summation processing includes: the summing circuit 230 sums the exponential function value exp_i to generate a total value; the summing circuit 230 calculates the reciprocal of the total value as the combined value c2. The arithmetic processing includes: the arithmetic circuit 240 performs the multiplication computation by using the linear combination vector r_i and the combined value c2 to generate a product vector as the attention scoring vector OUT2.

In other embodiments, the summation processing includes: the summing circuit 230 sums the exponential function value exp_i to generate a total value as the combined value c2. The arithmetic processing includes: the arithmetic circuit 240 performs a division computation by using the linear combination vector r_i and the combined value c2 to generate a quotient vector as the attention scoring vector OUT2.

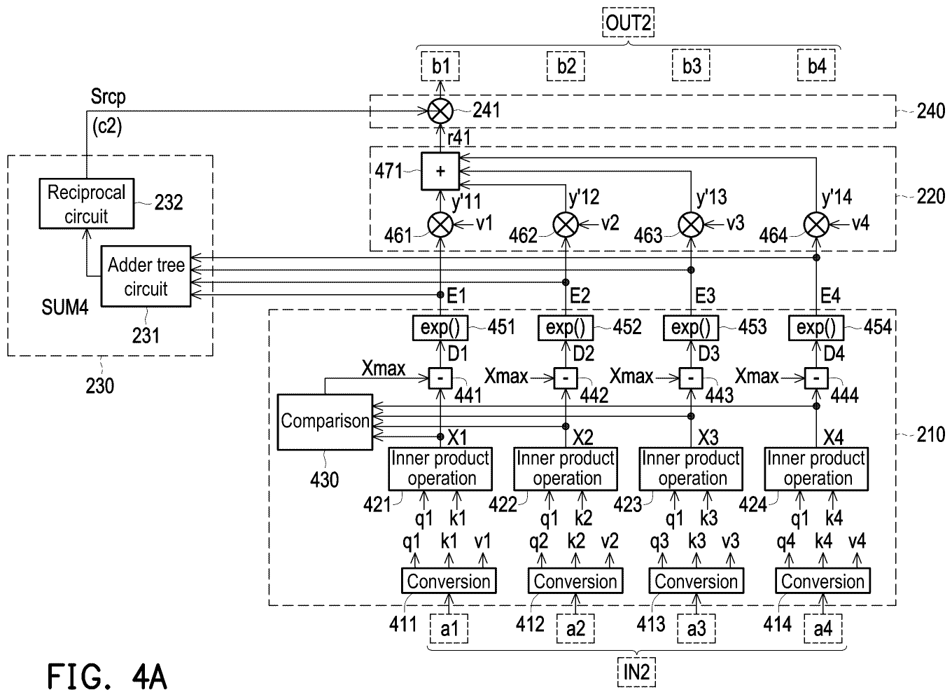

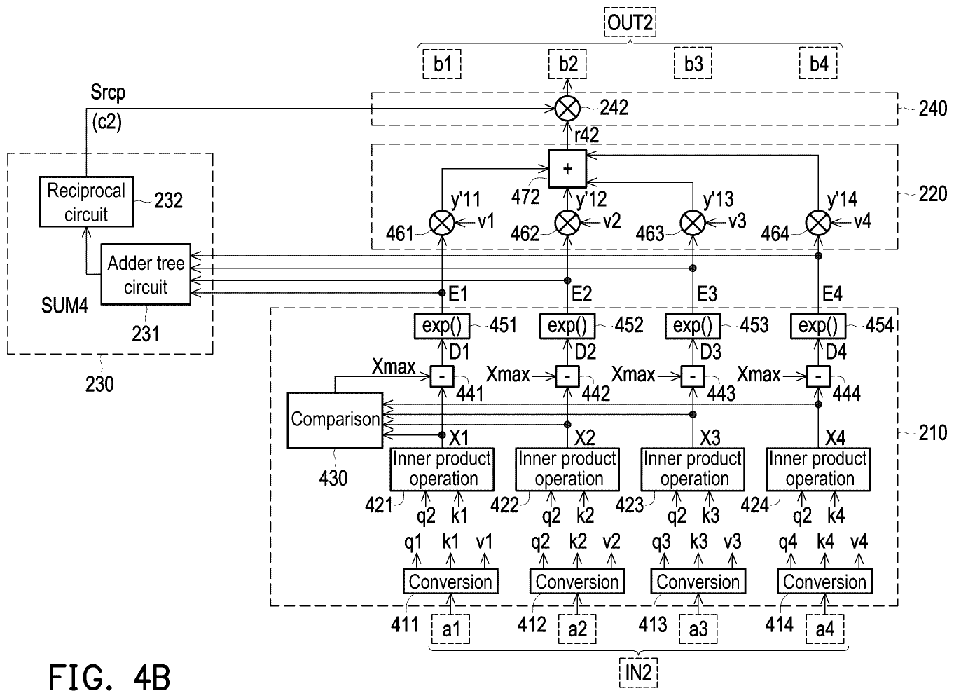

FIG. 4A and FIG. 4B illustrate circuit block diagrams of the pre-processing circuit 210, the post-processing circuit 220, the summing circuit 230, and the arithmetic circuit 240 according to an embodiment of this disclosure. The pre-processing circuit 210, the post-processing circuit 220, the summing circuit 230, and the arithmetic circuit 240 shown in FIG. 4A and FIG. 4B may serve as one of many exemplary embodiments of the pre-processing circuit 210, the post-processing circuit 220, the summing circuit 230, and the arithmetic circuit 240 shown in FIG. 2. The relevant descriptions of the pre-processing circuit 210, the post-processing circuit 220, the summing circuit 230, and the arithmetic circuit 240 shown in FIG. 4A and FIG. 4B may be referred to as the relevant description depicted in FIG. 2. In the exemplary embodiment shown in FIG. 4A and FIG. 4B, the sequence length is assumed to be 4; that is, the at least one input vector IN2 has four vectors, namely the input vectors a1, a2, a3, and a4. Generally, the sequence length is greater than 4, for instance, 32, 64, 256, 1024, 2048, 4096, 8192, or even larger. The dimensions of the input vectors a1, a2, a3, and a4 are determined according to the actual design and application requirements. For instance, the dimension of each of the input vectors a1, a2, a3, and a4 may be 10080 or another specified value.

In the embodiment shown in FIG. 4A and FIG. 4B, the pre-processing circuit 210 includes at least one conversion circuit (e.g., conversion circuits 411, 412, 413, and 414 shown in FIG. 4A and FIG. 4B), at least one inner product circuit (e.g., inner product circuits 421, 422, 423, and 424 shown in FIG. 4A and FIG. 4B), a comparison circuit 430, at least one subtraction circuit (e.g., subtraction circuits 441, 442, 443, and 444 shown in FIG. 4A and FIG. 4B), and at least one exponential function circuit (e.g., exponential function circuits 451, 452, 453, and 454 shown in FIG. 4A and FIG. 4B). Each conversion circuit converts the corresponding input vector into a query vector, a key vector, and a value vector. Specifically, each conversion circuit multiplies the corresponding input vector by different trained weights to generate the query vector, the key vector, and the value vector. For instance, the conversion circuit 411 multiplies the corresponding input vector al by the Q matrix, the K matrix, and the V matrix (trained weights) respectively to generate the query vector q1, the key vector k1, and the value vector v1 corresponding to the input vector a1. Similarly, the conversion circuit 412 converts the corresponding input vector a2 into the query vector q2, the key vector k2, and the value vector v2, the conversion circuit 413 converts the corresponding input vector a3 into the query vector q3, the key vector k3, and the value vector v3, and the conversion circuit 414 converts the corresponding input vector a4 into the query vector q4, the key vector k4, and the value vector v4.

The inner product circuits 421 to 424 are coupled to the conversion circuits 411 to 414. The inner product circuits 421 to 424 perform inner product computations by using the query vectors q1 to q4 and the key vectors k1 to k4 to generate inner product values X1, X2, X3, and X4. The comparison circuit 430 is coupled to the inner product circuits 421 to 424 and the subtraction circuits 441 to 444. For instance, the operation scenario shown in FIG. 4A is directed to the attention mechanism initiated by the vector q1. the inner product circuit 421 uses the query vector q1 and the key vector k1 to generate the inner product value X1 to the comparison circuit 430 and the subtraction circuit 441, the inner product circuit 422 uses the query vector q1 and the key vector k2 to generate the inner product value X2 to the comparison circuit 430 and the subtraction circuit 442, the inner product circuit 423 uses the query vector q1 and the key vector k3 to generate the inner product value X3 to the comparison circuit 430 and the subtraction circuit 443, and the inner product circuit 424 uses the query vector q1 and the key vector k4 to generate the inner product value X4 to the comparison circuit 430 and the subtraction circuit 444. In another example, the operation scenario shown in FIG. 4B is directed to the attention mechanism initiated by the vector q2, the inner product circuit 421 uses the query vector q2 and the key vector k1 to generate the inner product value X1 to the comparison circuit 430 and the subtraction circuit 441, the inner product circuit 422 uses the query vector q2 and the key vector k2 to generate the inner product value X2 to the comparison circuit 430 and the subtraction circuit 442, the inner product circuit 423 uses the query vector q2 and the key vector k3 to generate the inner product value X3 to the comparison circuit 430 and the subtraction circuit 443, and the inner product circuit 424 uses the query vector q2 and the key vector k4 to generate the inner product value X4 to the comparison circuit 430 and the subtraction circuit 444.

The subtraction circuits 441 to 444 are coupled to the inner product circuits 421 to 424, so as to receive the inner product values X1 to X4. The comparison circuit 430 compares the inner product values X1 to X4 to find the maximum inner product value Xmax. The subtraction circuits 441 to 444 are coupled to the comparison circuit 430 to receive the maximum inner product value Xmax. The subtraction circuits 441 to 444 use the inner product values X1 to X4 and the maximum inner product value Xmax to perform subtraction computations, so as to generate the differences D1, D2, D3, and D4. For instance, the subtraction circuit 441 performs the subtraction computation by using the inner product value X1 and the maximum inner product value Xmax to generate the difference D1=X1−Xmax to the exponential function circuit 451. Similarly, the subtraction circuit 442 generates the difference D2=X2−Xmax to the exponential function circuit 452, the subtraction circuit 443 generates the difference D3=X3−Xmax to the exponential function circuit 453, and the subtraction circuit 444 generates the difference D4=X4−Xmax to the exponential function circuit 454.

The exponential function circuits 451 to 454 are coupled to the subtraction circuits 441 to 444. The exponential function circuits 451 to 454 perform exponential function computations by using the differences D1 to D4 to generate exponential function values exp_i (e.g., exponential function values E1, E2, E3, and E4 as shown in FIG. 4A and FIG. 4B). For instance, the exponential function circuit 451 performs the exponential function computation by using the difference D1 to generate the exponential function value E1=exp(D1) to the post-processing circuit 220 and the summing circuit 230. Similarly, the exponential function circuit 452 performs the exponential function computation by using the difference D2 to generate the exponential function value E2=exp(D2) to the post-processing circuit 220 and the summing circuit 230, the exponential function circuit 453 performs the exponential function computation by using the difference D3 to generate the exponential function value E3=exp(D3) to the post-processing circuit 220 and the summing circuit 230, and the exponential function circuit 454 performs the exponential function computation by using the difference D4 to generate the exponential function value E4=exp(D4) to the post-processing circuit 220 and the summing circuit 230.

In the embodiment shown in FIG. 4A, the post-processing circuit 220 includes at least one multiplication circuit (e.g., multiplication circuits 461, 462, 463, and 464 as shown in FIG. 4A) and a linear combination circuit 471. In the embodiment shown in FIG. 4B, the post-processing circuit 220 includes the multiplication circuits 461 to 464 and a linear combination circuit 472. Each multiplication circuit is coupled to the pre-processing circuit 210 to receive a corresponding exponential function value and a corresponding value vector. The multiplication circuits 461 to 464 perform multiplication computations by using the corresponding exponential function values and the corresponding value vectors to generate corresponding product vectors y′i (e.g., product vectors y′11, y′12, y′13, and y′14 as shown in FIG. 4A or FIG. 4B) to the linear combination circuit 471. For instance, the multiplication circuit 461 performs the multiplication computation by using the exponential function value E1 and the value vector v1 to generate the corresponding product vector y′11=E1*v1 to the linear combination circuit 471. Similarly, the multiplication circuit 462 performs the multiplication computation by using the exponential function value E2 and the value vector v2 to generate the corresponding product vector y′12=E2*v2 to the linear combination circuit 471, the multiplication circuit 463 performs the multiplication computation by using the exponential function value E3 and the value vector v3 to generate the corresponding product vector y′13=E3*v3 to the linear combination circuit 471, and the multiplication circuit 464 performs the multiplication computation by using the exponential function value E4 and the value vector v4 to generate the corresponding product vector y′14=E4*v4 to the linear combination circuit 471. The linear combination circuit 471 is coupled to the multiplication circuits 461 to 464 and the arithmetic circuit 240.

The linear combination circuit 471 performs the linear combination computation by using the product vectors y′11 to y′14 to generate a linear combination vector r_i (e.g., the linear combination vector r41 as shown in FIG. 4A, or the linear combination vector r42 as shown in FIG. 4B). For instance, the operation scenario shown in FIG. 4A is directed to the attention mechanism initiated by the vector q1, and the linear combination circuit 471 of the post-processing circuit 220 performs the linear combination computation (e.g., a vector addition computation) by using the product vectors y′11 to y′14 to generate the linear combination vector r41=y′11+y′12+y′13+y′14 to the multiplication circuit 241 of the arithmetic circuit 240. In another example, the operation scenario shown in FIG. 4B is directed to the attention mechanism initiated by the vector q2, and the linear combination circuit 472 of the post-processing circuit 220 performs the linear combination computation (e.g., the vector addition computation) by using the product vectors y′11 to y′14 to generate the linear combination vector r42=y′11+y′12+y′13+y′14 to the multiplication circuit 242 of the arithmetic circuit 240.

In the embodiments shown in FIG. 4A and FIG. 4B, the summing circuit 230 includes an adder tree circuit 231 and a reciprocal circuit 232. The adder tree circuit 231 is coupled to the pre-processing circuit 210 to receive exponential function values exp_i (e.g., the exponential function values E1 to E4 shown in FIG. 4A and FIG. 4B). The adder tree circuit 231 sums the exponential function values E1 to E4 to generate a total value SUM4=E1+E2 +E3+E4. The reciprocal circuit 232 is coupled to the adder tree circuit 231 to receive the total value SUM4. The reciprocal circuit 232 is further coupled to the arithmetic circuit 240. The reciprocal circuit 232 calculates the reciprocal Srcp of the total value SUM4 as the combined value c2.

In FIG. 4A and FIG. 4B, it is assumed that the attention scoring vector OUT2 includes output vectors b1, b2, b3 and b4. The multiplication circuit 241 of the arithmetic circuit 240 shown in FIG. 4A is coupled to the post-processing circuit 220 and the summing circuit 230. The operation scenario shown in FIG. 4A is directed to the attention mechanism initiated by the vector q1, and the multiplication circuit 241 of the arithmetic circuit 240 performs the multiplication computation by using the linear combination vector r41 and the reciprocal Srcp (the combined value c2) to generate a product vector as the output vector b1 in the attention scoring vector OUT2. The multiplication circuit 242 of the arithmetic circuit 240 shown in FIG. 4B is coupled to the post-processing circuit 220 and the summing circuit 230. The operation scenario shown in FIG. 4B is directed to the attention mechanism initiated by the vector q2, and the multiplication circuit 242 of the arithmetic circuit 240 performs the multiplication computation by using the linear combination vector r42 and the reciprocal Srcp (the combined value c2) to generate a product vector as the output vector b2 in the attention scoring vector OUT2. The generation of the output vectors b3 and b4 may be deduced from the relevant descriptions depicted in FIG. 4A and FIG. 4B and therefore will not be repeated here.

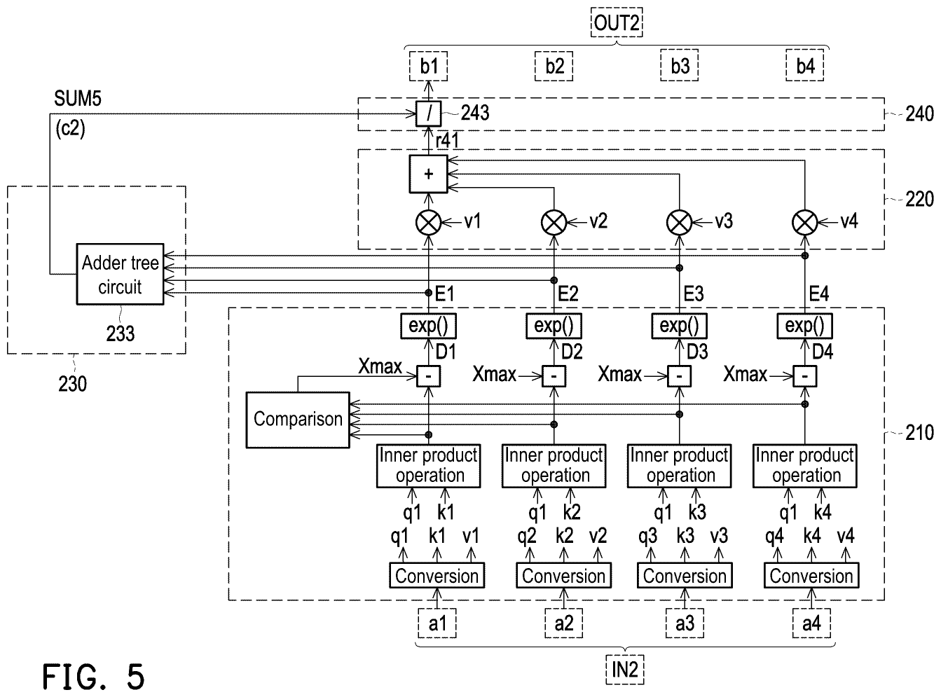

FIG. 5 is a circuit block diagram illustrating the summing circuit 230 and the arithmetic circuit 240 according to another embodiment of the disclosure. The summing circuit 230 and the arithmetic circuit 240 shown in FIG. 5 may serve as one of many exemplary embodiments of the summing circuit 230 and the arithmetic circuit 240 shown in FIG. 2. In the exemplary embodiment shown in FIG. 5, the sequence length is assumed to be 4. Generally, the sequence length is greater than 4, e.g., 32, 64, 256, 1024, 2048, 4096, 8192, or even larger. The relevant descriptions of pre-processing circuit 210, the post-processing circuit 220, the summing circuit 230, and the arithmetic circuit 240 shown in FIG. 5 may be referred to as the relevant description depicted in FIG. 4A and FIG. 4B.

In the embodiment shown in FIG. 5, the summing circuit 230 includes an adder tree circuit 233, and the arithmetic circuit 240 includes a division circuit 243. The adder tree circuit 233 is coupled to the pre-processing circuit 210 and the arithmetic circuit 240. The adder tree circuit 233 sums the exponential function values E1 to E4 to generate a total value SUM5 as the combined value c2. The division circuit 243 is coupled to the post-processing circuit 220 and the summing circuit 230. The division circuit 243 performs a division computation by using the linear combination vector r41 and the total value SUM5 (the combined value c2) to generate a quotient vector as the output vector b1 in the attention scoring vector OUT2.

To sum up, the summing circuit 230 performs the summation processing by using the exponential function values E1 to E4 generated by the attention scoring pre-processing to generate the combined value c2. Then, the arithmetic circuit 240 performs the arithmetic processing by using the linear combination vector (e.g., the linear combination vector r41 shown in FIG. 4A or FIG. 5, or the linear combination vector r42 shown in FIG. 4B) generated by the attention scoring post-processing and the combined value c2 generated by the summing circuit 230 to generate the attention scoring vector OUT2. Compared to the normalized function (e.g., the Softmax function) shown in FIG. 1 where the division computation is performed on each of numerous exponential function values (namely, the division computation is performed on each exponential function value before the attention scoring post-processing), the arithmetic circuit 240 depicted in FIG. 4A to 4B or FIG. 5 performs the arithmetic processing (e.g., the multiplication computation or the division computation) on the linear combination vector after the attention scoring post-processing. Therefore, the attention scoring device 200 may eliminate the number of division computations (i.e., the “/” shown in FIG. 1) in the normalized function shown in FIG. 1, thereby efficiently executing the calculation of the attention scoring function.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An attention scoring device, comprising:
a pre-processing circuit, performing attention scoring pre-processing by using at least one input vector to generate at least one exponential function value and at least one value vector corresponding to the at least one input vector;
a post-processing circuit, coupled to the pre-processing circuit to receive the at least one exponential function value and the at least one value vector, wherein the post-processing circuit performs attention scoring post-processing by using the at least one exponential function value and the at least one value vector to generate a linear combination vector;
a summing circuit, coupled to the pre-processing circuit to receive the at least one exponential function value, wherein the summing circuit performs summation processing by using the at least one exponential function value to generate a combined value; and
an arithmetic circuit, coupled to the post-processing circuit to receive the linear combination vector and coupled to the summing circuit to receive the combined value, wherein the arithmetic circuit performs arithmetic processing by using the linear combination vector and the combined value to generate an attention scoring vector corresponding to the at least one input vector.

2. The attention scoring device according to claim 1, wherein the attention scoring pre-processing comprises:
converting the at least one input vector into at least one query vector, at least one key vector, and the at least one value vector;
performing an inner product computation by using the at least one query vector and the at least one key vector to generate at least one inner product value;
comparing the at least one inner product value to find a maximum inner product value;
performing a subtraction computation by using the at least one inner product value and the maximum inner product value to generate at least one difference; and
performing an exponential function computation by using the at least one difference to generate the at least one exponential function value.

3. The attention scoring device according to claim 2, wherein the conversion of the at least one input vector into the at least one query vector, the at least one key vector, and the at least one value vector comprises:
multiplying the at least one input vector by different trained weights to generate the at least one query vector, the at least one key vector, and the at least one value vector corresponding to the at least one input vector.

4. The attention scoring device according to claim 1, wherein the attention scoring post-processing comprises:
performing a multiplication computation by using the at least one exponential function value and the at least one value vector to generate at least one product vector; and
performing a linear combination computation by using the at least one product vector to generate the linear combination vector.

5. The attention scoring device according to claim 4, wherein the linear combination computation comprises:
performing an addition computation by using the at least one product vector to generate the linear combination vector.

6. The attention scoring device according to claim 1, wherein the summation processing comprises:
summing the at least one exponential function value to generate a total value; and
calculating a reciprocal of the total value as the combined value.

7. The attention scoring device according to claim 1, wherein the arithmetic processing comprises:
performing a multiplication computation by using the linear combination vector and the combined value to generate a product vector as the attention scoring vector.

8. The attention scoring device according to claim 1, wherein the summation processing comprises:
summing the at least one exponential function value to generate a total value as the combined value.

9. The attention scoring device according to claim 1, wherein the arithmetic processing comprises:
performing a division computation by using the linear combination vector and the combined value to generate a quotient vector as the attention scoring vector.

10. The attention scoring device according to claim 1, wherein the pre-processing circuit comprises:
at least one conversion circuit, wherein the at least one conversion circuit converts the at least one input vector into at least one query vector, at least one key vector, and the at least one value vector;
at least one inner product circuit, coupled to the at least one conversion circuit, wherein the at least one inner product circuit performs an inner product computation by using the at least one query vector and the at least one key vector to generate at least one inner product value;
a comparison circuit, coupled to the at least one inner product circuit, wherein the comparison circuit compares the at least one inner product value to find a maximum inner product value;
at least one subtraction circuit, coupled to the at least one inner product circuit and the comparison circuit, wherein the at least one subtraction circuit performs a subtraction computation by using the at least one inner product value and the maximum inner product value to generate at least one difference; and
at least one exponential function circuit, coupled to the at least one subtraction circuit. wherein the at least one exponential function circuit performs an exponential function computation by using the at least one difference to generate the at least one exponential function value.

11. The attention scoring device according to claim 10, wherein the at least one conversion circuit multiplies the at least one input vector by different trained weights to generate the at least one query vector, the at least one key vector, and the at least one value vector corresponding to the at least one input vector.

12. The attention scoring device according to claim 1, wherein the post-processing circuit comprises:
at least one multiplication circuit, coupled to the pre-processing circuit, wherein the at least one multiplication circuit performs a multiplication computation by using the at least one exponential function value and the at least one value vector to generate at least one product vector; and
a linear combination circuit, coupled to the at least one multiplication circuit and the arithmetic circuit, wherein the linear combination circuit performs a linear combination computation by using the at least one product vector to generate the linear combination vector.

13. The attention scoring device according to claim 12, wherein the linear combination circuit performs an addition computation by using the at least one product vector to generate the linear combination vector.

14. The attention scoring device according to claim 1, wherein the summing circuit comprises:
an adder tree circuit, coupled to the pre-processing circuit, wherein the adder tree circuit sums the at least one exponential function value to generate a total value; and
a reciprocal circuit, coupled to the adder tree circuit and the arithmetic circuit, wherein the reciprocal circuit calculates a reciprocal of the total value as the combined value.

15. The attention scoring device according to claim 1, wherein the arithmetic circuit comprises:
a multiplication circuit, coupled to the post-processing circuit and the summing circuit, wherein the multiplication circuit performs a multiplication computation by using the linear combination vector and the combined value to generate a product vector as the attention scoring vector.

16. The attention scoring device according to claim 1, wherein the summing circuit comprises:
an adder tree circuit, coupled to the pre-processing circuit and the arithmetic circuit, wherein the adder tree circuit sums the at least one exponential function value to generate a total value as the combined value.

17. The attention scoring device according to claim 1. further comprising:
a division circuit, coupled to the post-processing circuit and the summing circuit, wherein the division circuit performs a division computation by using the linear combination vector and the combined value to generate a quotient vector as the attention scoring vector.

18. An operating method of an attention scoring device, comprising:
performing attention scoring pre-processing by using at least one input vector by a pre-processing circuit of the attention scoring device to generate at least one exponential function value and at least one value vector corresponding to the at least one input vector;
performing attention scoring post-processing by using the at least one exponential function value and the at least one value vector by a post-processing circuit of the attention scoring device to generate a linear combination vector;
performing summation processing by using the at least one exponential function value by a summing circuit of the attention scoring device to generate a combined value; and
performing arithmetic processing by using the linear combination vector and the combined value by an arithmetic circuit of the attention scoring device to generate an attention scoring vector corresponding to the at least one input vector.

19. The operating method according to claim 18, wherein the attention scoring pre-processing comprises:
converting the at least one input vector into at least one query vector, at least one key vector, and the at least one value vector;
performing an inner product computation by using the at least one query vector and the at least one key vector to generate at least one inner product value;
comparing the at least one inner product value to find a maximum inner product value;
performing a subtraction computation by using the at least one inner product value and the maximum inner product value to generate at least one difference; and
performing an exponential function computation by using the at least one difference to generate the at least one exponential function value.

20. The operating method according to claim 19, wherein the conversion of the at least one input vector into the at least one query vector, the at least one key vector, and the at least one value vector comprises:
multiplying the at least one input vector by different trained weights to generate the at least one query vector, the at least one key vector, and the at least one value vector corresponding to the at least one input vector.

21. The operating method according to claim 18, wherein the attention scoring post-processing comprises:
performing a multiplication computation by using the at least one exponential function value and the at least one value vector to generate at least one product vector; and
performing a linear combination computation by using the at least one product vector to generate the linear combination vector.

22. The operating method according to claim 21, wherein the linear combination computation comprises:
performing an addition computation by using the at least one product vector to generate the linear combination vector.

23. The operating method according to claim 18, wherein the summation processing comprises:
summing the at least one exponential function value to generate a total value; and
calculating a reciprocal of the total value as the combined value.

24. The operating method according to claim 18, wherein the arithmetic processing comprises:
performing a multiplication computation by using the linear combination vector and the combined value to generate a product vector as the attention scoring vector.

25. The operating method according to claim 18, wherein the summation processing comprises:
summing the at least one exponential function value to generate a total value as the combined value.

26. The operating method according to claim 18, wherein the arithmetic processing comprises:
performing a division computation by using the linear combination vector and the combined value to generate a quotient vector as the attention scoring vector.
